(19) United States
(12) Patent Application Publication
(10) Pub. No.: US 2017/0244168 A1
(43) Pub. Date: Aug. 24, 2017

(54) SMALL FORM FACTOR ANTENNA

(71) Applicant: AirWire Technologies, Reno, NV (US)

(72) Inventor: Forrest Wolf, Reno, NV (US)

(21) Appl. No.: 15/047,546

(22) Filed: Feb. 18, 2016

(51) Int. Cl. H01Q 9/04; H01Q 1/38

(52) U.S. Cl. CPC H01Q 9/04; H01Q 1/38

(57) ABSTRACT

A printed circuit board (PCB) includes a front side and a back side. A first conducting element disposed on the front side resonates over a first range of frequencies. A second conducting element disposed on the back side resonates over a second range of frequencies. A ground conducting element disposed on the front side where a first portion of the ground conducting element provides a ground reference for the first conducting element. A second portion of the ground conducting element provides a ground reference for the second conducting element. Resonance over the first range of frequencies is associated with a length of the first portion of the ground conducting element and a length of the first conducing element. Resonance over the second range of frequencies is associated with a length of the second portion of the ground conducting element and a length of the second conducting element.

### BACKGROUND

Mobile devices such as smart phones have become prevalent in recent years. As such, use of the antenna to receive and transmit signals has become an important aspect of the mobile device industry in order to have sufficient gain.

Mobile devices are becoming smaller every day while more and more functionality is added. Thus, space for placing an antenna and to have sufficient gain has become challenging. Often, antennas are designed without sufficient gain in order to fit into smaller spaces.

### SUMMARY

Accordingly, a need has arisen to design antennas that take minimal real estate space in a mobile device while having sufficient gain for various frequencies. These and various other features and advantages will be apparent from a reading of the following detailed description.

According to some embodiments, an antenna includes a dielectric material including a front side and a back side, wherein the front side is opposite the back side; a first planar conducting element disposed on the front side configured to resonate over a first range of frequencies; a second planar conducting element disposed on the back side configured to resonate over a second range of frequencies; and a ground planar conducting element disposed on the front side. A first portion of the ground planar conducting element may be configured to provide a ground reference for the first planar conducting element. A second portion of the ground planar conducting element may be configured to provide a ground reference for the second planar conducting element. It is appreciated that resonance over the first range of frequencies may be associated with a length of the first portion of the ground planar conducting element and a length of the first planar conducing element. Moreover, it is appreciated that resonance over the second range of frequencies may be associated with a length of the second portion of the ground planar conducting element and a length of the second planar conducting element.

The antenna may further include a third planar conducting element disposed on the front side configured to resonate over a third range of frequencies. The first portion of the ground planar conducting element may be further configured to provide the ground reference for the third planar conducting element. According to one embodiment, resonance over the third range of frequencies may be associated with the length of the first portion of the ground planar conducting element and a length of the third planar conducting element.

The antenna may include a plurality of vias configured to electrically connect the first planar conducting element and the third planar conducting element to a fourth conducting element disposed on the back side for increasing reference plane capacitance associated with the first planar conducting element and the third planar conducting element.

It is appreciated that in some embodiments, the third range of frequencies may be between 1500-2000 MHz. It is appreciated that the first range of frequencies may be between 800-900 MHz and the second range of frequencies may be between 2000-2500 MHz.

According to some embodiments, the first planar conducting element and the second planar conducting element are non-overlapping. It is appreciated that in one exemplary embodiment, the first planar conducting element, the second planar conducting element, and the third planar conducting element are non-overlapping. In some embodiments the antenna may further include a via hole configured to couple the second planar conducting element to the second portion of the ground planar conducting element.

In one exemplary embodiment, the length of the first planar conducting element and the length of the first portion of the ground planar conducting element may be configured to capture a quarter wavelength signal for the first range of frequencies. In some embodiments, the length of the first planar conducting element and the length of the first portion of the ground planar conducting element may be configured to capture a quarter wavelength signal for the first range of frequencies and is at least two and a half times the length of the second planar conducting element and the length of the second portion of the ground planar conducting element that may be configured to capture a quarter wavelength signal for the second range of frequencies. It is appreciated that the length of the first planar conducting element and the length of the first portion of the ground planar conducting element may be configured to capture a quarter wavelength signal for the first range of frequencies associated with long term evolution (LTE).

It is appreciated that the dielectric material may include FR4 material. According to some embodiments, the dielectric material, the first planar conducting element, the second planar conducting element, and the ground planar are disposed on a printed circuit board (PCB). It is appreciated that the antenna may have a small form factor configured to be placed within a smartphone.

According to some embodiments, an antenna may include a printed circuit board (PCB) including a front side and a back side, wherein the front side is opposite the back side; a first conducting element disposed on the front side configured to resonate over a first range of frequencies; a second conducting element disposed on the back side configured to resonate over a second range of frequencies; and a ground conducting element disposed on the front side. A first portion of the ground conducting element may be configured to provide a ground reference for the first conducting element. A second portion of the ground conducting element may be configured to provide a ground reference for the second conducting element. It is appreciated that resonance over the first range of frequencies may be associated with a length of the first portion of the ground conducting element and a length of the first conducing element. In some embodiments resonance over the second range of frequencies may be associated with a length of the second portion of the ground conducting element and a length of the second conducting element.

The antenna may further include a third conducting element disposed on the front side configured to resonate over a third range of frequencies. The first portion of the ground conducting element may be further configured to provide the ground reference for the third conducting element. It is appreciated that resonance over the third range of frequencies may be associated with the length of the first portion of the ground conducting element and a length of the third conducting element. In some embodiments, the antenna may also include a plurality of vias configured to electrically connect the first conducting element and the third conducting element to a fourth conducting element disposed on the back side for increasing reference plane capacitance associated with the first conducting element and the third conducting element.

It is appreciated that the third range of frequencies may be between 1500-2000 MHz. In some embodiments, the first range of frequencies is between 800-900 MHz and the second range of frequencies is between 2000-2500 MHz.

In some embodiments, the first conducting element, the second conducting element, and the third conducting element may be non-overlapping. It is appreciated that in some embodiments the first conducting element and the second conducting element may be non-overlapping.

The antenna may further include a via hole configured to couple the second conducting element to the second portion of the ground conducting element.

In some exemplary embodiments, the length of the first conducting element and the length of the first portion of the ground conducting element may be configured to capture a quarter wavelength signal for the first range of frequencies. Moreover, it is appreciated that according to some embodiments the length of the first conducting element and the length of the first portion of the ground conducting element may be configured to capture a quarter wavelength signal for the first range of frequencies and is at least two and a half times the length of the second conducting element and the length of the second portion of the ground conducting element that may be configured to capture a quarter wavelength signal for the second range of frequencies. Furthermore, in some embodiments, the length of the first conducting element and the length of the first portion of the ground conducting element may be configured to capture a quarter wavelength signal for the first range of frequencies associated with long term evolution (LTE).

It is appreciated that in some embodiments, the PCB may include FR4 material. Moreover, it is appreciated that the antenna may have a small form factor configured to be placed within a smartphone.

In some embodiments, a smartphone may include a printed circuit board (PCB) including a front side and a back side, wherein the front side is opposite the back side; a first conducting element disposed on the front side may be configured to resonate over a first range of frequencies; a second conducting element disposed on the back side may be configured to resonate over a second range of frequencies; and a ground conducting element disposed on the front side. A first portion of the ground conducting element may be configured to provide a ground reference for the first conducting element. A second portion of the ground conducting element may be configured to provide a ground reference for the second conducting element. It is appreciated that resonance over the first range of frequencies may be associated with a length of the first portion of the ground conducting element and a length of the first conducing element. It is appreciated that resonance over the second range of frequencies may be associated with a length of the second portion of the ground conducting element and a length of the second conducting element. The PCB may be positioned within the smartphone. In some embodiments, the PCB may include FR4 material.

According to some embodiments, the smartphone may include a third conducting element disposed on the front side configured to resonate over a third range of frequencies. The first portion of the ground conducting element may be further configured to provide the ground reference for the third conducting element. It is appreciated that resonance over the third range of frequencies may be associated with the length of the first portion of the ground conducting element and a length of the third conducting element.

The smartphone may also include a plurality of vias configured to electrically connect the first conducting element and the third conducting element to a fourth conducting element disposed on the back side for increasing reference plane capacitance associated with the first conducting element and the third conducting element. The smartphone may include a via hole configured to couple the second conducting element to the second portion of the ground conducting element.

It is appreciated that the third range of frequencies may be between 1500-2000 MHz. In some exemplary embodiments, the first range of frequencies may be between 800-900 MHz and the second range of frequencies is between 2000-2500 MHz.

It is appreciated that the first conducting element, the second conducting element, and the third conducting element may be non-overlapping. Moreover, the first conducting element and the second conducting element may only be non-overlapping.

It is appreciated that the length of the first conducting element and the length of the first portion of the ground conducting element may be configured to capture a quarter wavelength signal for the first range of frequencies. According to some embodiments, the length of the first conducting element and the length of the first portion of the ground conducting element may be configured to capture a quarter wavelength signal for the first range of frequencies and is at least two and a half times the length of the second conducting element and the length of the second portion of the ground conducting element that may be configured to capture a quarter wavelength signal for the second range of frequencies. It is appreciated that the length of the first conducting element and the length of the first portion of the ground conducting element may be configured to capture a quarter wavelength signal for the first range of frequencies associated with long term evolution (LTE).

These and other features and aspects may be better understood with reference to the following drawings, description, and appended claims

### BRIEF DESCRIPTION OF DRAWINGS

The present invention is illustrated by way of example, and not by way of limitation, in the figures of the accompanying drawings and in which like reference numerals refer to similar elements.

FIG. 1 shows a first side of an antenna according to some embodiments.

FIG. 2 shows a second side of an antenna of FIG. 1 according to some embodiments.

FIG. 3 shows the first side and the second side of the antenna of FIGS. 1 and 2 according to some embodiments.

FIG. 4 shows a first side of an antenna according to a different embodiment.

FIG. 5 shows the first side and the second side of an antenna of FIG. 4 according to some embodiments.

FIG. 6 shows an antenna according to some alternative embodiments.

FIG. 7 shows two antennas integrated within according to some embodiments.

FIGS. 8A-8B show a side view and a top view of an antenna according to some embodiments.

FIG. 9 shows a stacked antenna according to some embodiments.

FIG. 10 shows an integrated antenna according to some embodiments.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications, and equivalents, which may be included within the scope of the invention as construed according to the appended Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details. In other instances, well known methods, procedures, components, and circuits have not been described in detail as not to unnecessarily obscure aspects of the invention.

It should also be understood by persons having ordinary skill in the art that the terminology used herein is for the purpose of describing the certain concepts, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “middle,” “bottom,” “forward,” “reverse,” “clockwise,” “counter clockwise,” “up,” “down,” “side,” or other similar terms such as “upper,” “lower,” “above,” “below,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

A need has arisen to design antennas that take minimal real estate space in a mobile device while having sufficient gain for various frequencies. Increased use of long term evolution (LTE) and similar technologies that use lower frequencies require larger antennas to have sufficient gain. As such, a need has also arisen to design antennas with small form factor suited for mobile devices such as smart phones while having sufficient gains for lower frequency bands, e.g., LTE technology, etc. For example, a need has arisen for antennas to capture quarter wavelength signals and resonate at lower frequencies while having small form factor.

According to some embodiments, a larger length antenna is designed to capture a quarter wavelength signal and to resonate over lower frequencies while it is packed into a small form factor. Embodiments described herein take advantage of front and back sides of the printed circuit board (PCB) to increase the length of the antenna in order to capture a quarter wavelength signal for resonating at lower frequencies. In some embodiments, the antennas are designed in a stacked structure to increase the length of the antenna for resonating over lower frequencies.

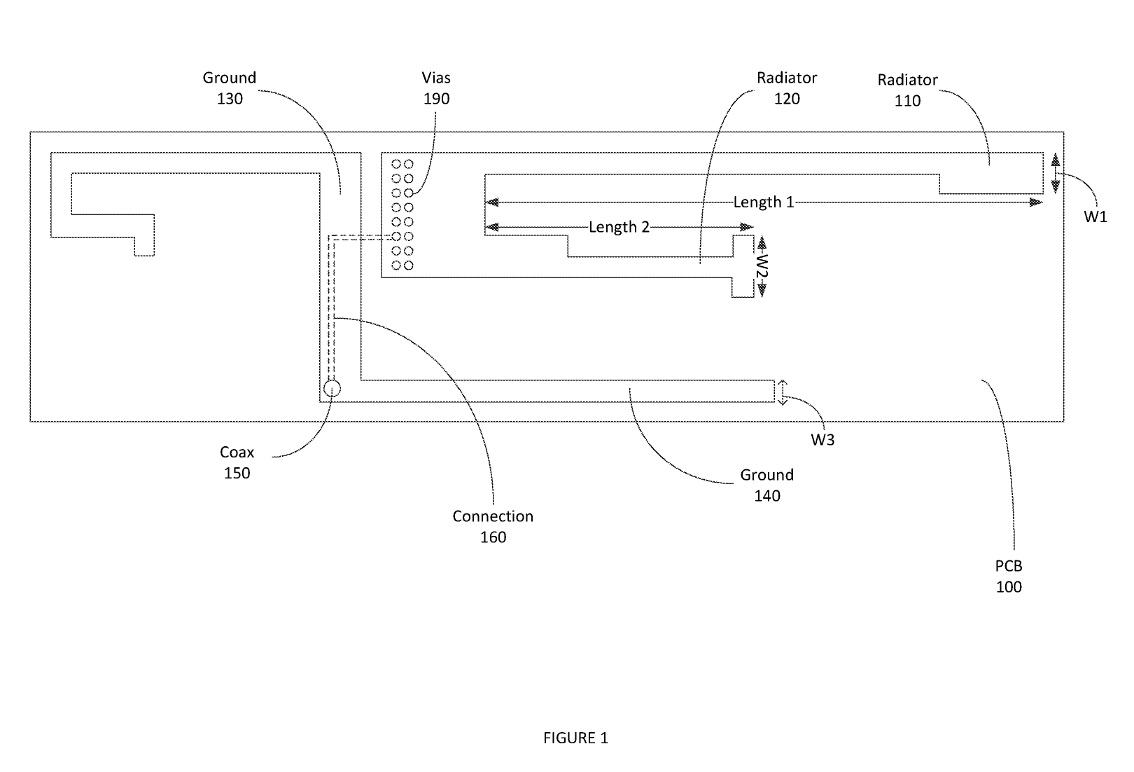

Referring now to FIG. 1, a first side of an antenna according to some embodiments is shown. A PCB 100 includes radiators 110 and 120, grounds 130 and 140, a coax 150 connection, an interconnection 160 for connecting the radiators 110 and 120 to the coax 150 connection, and vias 190 for connecting the radiators 110 and 120 to the back side of the PCB 100. In some embodiments, the vias 190 may be disposed on a via pad. The radiators 110 and 120 may be conducting elements, e.g., planar conducting element, etc.

It is appreciated that the radiator 110 has a length 1 and a width 1 and is configured to resonate over a center frequency and at a first frequency bandwidth, e.g., 800-900 MHz of LTE. Similarly, radiator 120 has a length 2 and a width 2 and is configured to resonate over another center frequency and a second frequency bandwidth, e.g., 1500-2000 MHz of LET. It is appreciated that the radiator 110 may be step shaped while radiator 120 is step shaped and one end of the radiator 120 is “T” shaped. The length of the radiators are configured to resonate over a center frequency while the width of the radiators may be configured to control the upper bound and lower bound range of the center frequency (also referred to as the bandwidth).

According to some embodiments, ground reference plane 130 is associated with radiators 110 and 120. In some embodiments, the length of the ground reference plane 130 includes an electrical connection, e.g., a wire, to an adjacent PCB in one embodiment, thereby extending the electrical length of the ground reference plane 130. It is appreciated that the electrical connection via a wire is exemplary and not intended to limit the scope of the embodiments, for example, in some embodiments more than one electrical connection may be used between the radiator and the adjacent PCB, thereby increasing the electrical length of another ground reference plane, e.g., ground reference plane 140.

It is appreciated that the length of the ground reference plane 130 and the radiator 110 is selected such that the radiator 110 resonate at a center frequency, e.g., 850 MHz of LTE, and captures a quarter wavelength of the signals within the range, e.g., 800-900 MHz. In some embodiments, the length of the ground reference plane 130 and the radiator 120 is selected such that the radiator 120 resonates at a center frequency, e.g. 1750 MHz of LTE, and captures a quarter wavelength of the signals within the range, e.g., 1500-2000 MHz. In some embodiments, the radiators 110 and 120 are non-overlapping radiators. It is appreciated that description of the embodiments with references to quarter wavelength is exemplary and not intended to limit the scope of the embodiments. For example, other wavelengths may be used, e.g., half wavelength, etc. It is also appreciated that in some embodiments, a dedicated ground reference plane may be used for each of the radiators 110 and 120 (not shown here).

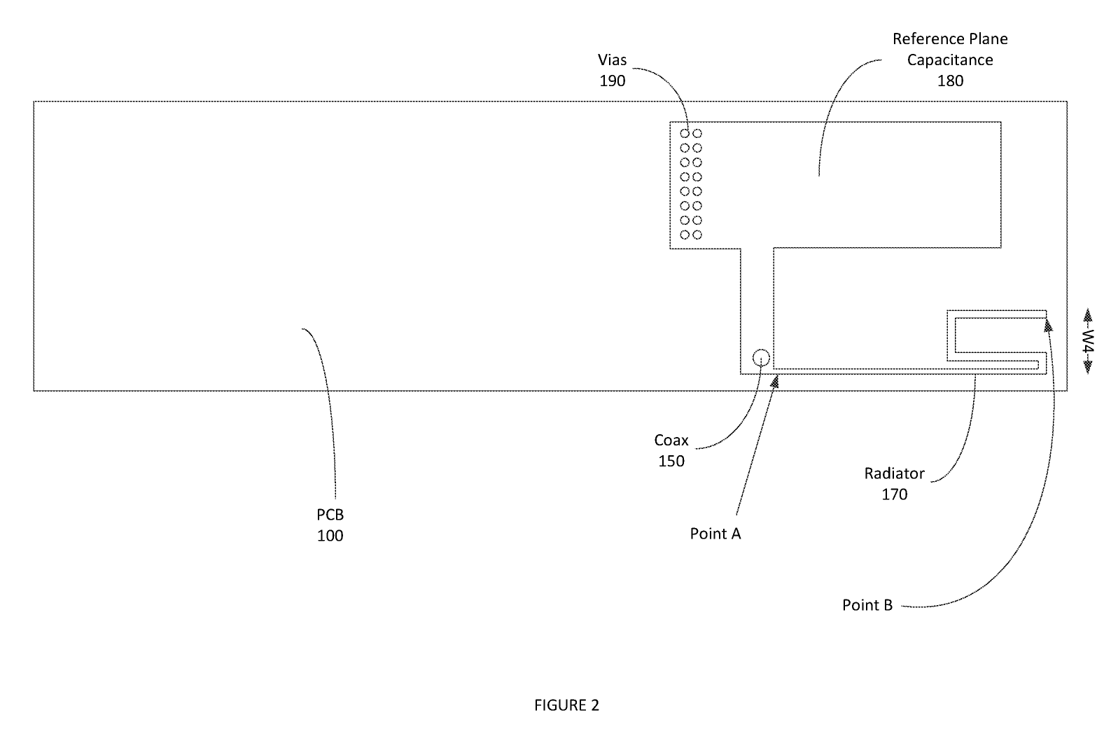

It is appreciated that the ground reference plane 140 may be associated with a radiator disposed on the back side of the PCB 100 (described with respect to FIG. 2 below). It is appreciated that the ground reference plane 140 may have a length and width associated therewith. The length of the ground reference plane 140 along with the length of its associated radiator may be configured such that the associated radiator resonates at a center frequency. Moreover, the width of the ground reference plane 140 may be configured to control the upper bound and the lower bound of the frequency range (also referred to as the bandwidth). It is appreciated that the lengths of the ground reference plane 140 with the length of its associated radiator may be configured such that the associated radiator resonates at the center frequency and captures a quarter wavelength signals at the center frequency.

According to some embodiments, the radiators 110 and 120 and the ground reference planes 130 and 140 may be printed on the PCB 100. In some embodiments, the printed radiators 110 and 120 and the ground reference planes 130 and 140 may be made of materials such as copper, aluminum, etc. The PCB 100 may include a dielectric material, e.g., FR4. It is appreciated that in some embodiments, the PCB 100 has a thickness of approximately 0.031″.

Referring now to FIG. 2, a second side of an antenna of FIG. 1 according to some embodiments is shown. The second side of the antenna of FIG. 1 includes a radiator 170, the coax 150 connection, the vias 190 making connections to the first side, and a reference plane capacitance 180. The radiator 170 may be a conducting element, e.g., a planar conducting element. The reference plane capacitance 180 may also be a conducting element, e.g., a planar conducting element, and it may add reference plane capacitance to the ground 130 on the first side of the PCB 100. The vias 190 couple the reference plane capacitance 180 to the radiators 110 and 120. The ground reference plane 140 is associated with the radiator 170. As such, the length of the radiator 170 between points A and B in addition to the length of the ground reference plane 140 is configured such that the radiator 170 resonates at a center frequency, e.g., 2250 MHz of LTE, and captures a quarter wavelength of the signals within the range, e.g., 2000-2500 MHz. It is appreciated that the width W4 of the radiator 170 is configured to select the bandwidth for which the radiator 170 resonates at. According to some embodiments, the length of the radiator 110 is at least two and a half times the length of the radiator 170. In other embodiments, the length of the radiator 110 and the length of the ground reference plane 130 is at least two and a half times the length of the radiator 170 and the length of the ground reference plane 140. As such, the center frequency that the radiator 110 resonates at is at least two and a half times less than the center frequency of the radiator 170.

In some embodiments, the radiators 110 and 170 are non-overlapping radiators. In some embodiments, the radiators 120 and 170 are non-overlapping radiators. Furthermore, in some embodiments, the radiators 110, 120, and 170 are non-overlapping radiators. It is appreciated that description of the embodiments with references to quarter wavelength is exemplary and not intended to limit the scope of the embodiments. For example, other wavelengths may be used, e.g., half wavelength, etc. Moreover, it is appreciated that the described embodiments that show two radiators on one side and one on the other side of the PCB, one ground reference plane shared by two radiators, and a dedicated ground reference plane by the radiator on the back side are exemplary and not intended to limit the scope of the embodiments. For example, any number of radiators and reference ground planes (whether shared by one or more radiators or not) may be used on one side, two sides, or a combination thereof.

According to some embodiments, the radiator 170 and the reference plane capacitance 180 may be printed on the PCB 100. In some embodiments, the radiator 170 and the reference plane capacitance 180 may be made of materials such as copper, aluminum, etc. The PCB 100 may include a dielectric material, e.g., FR4.

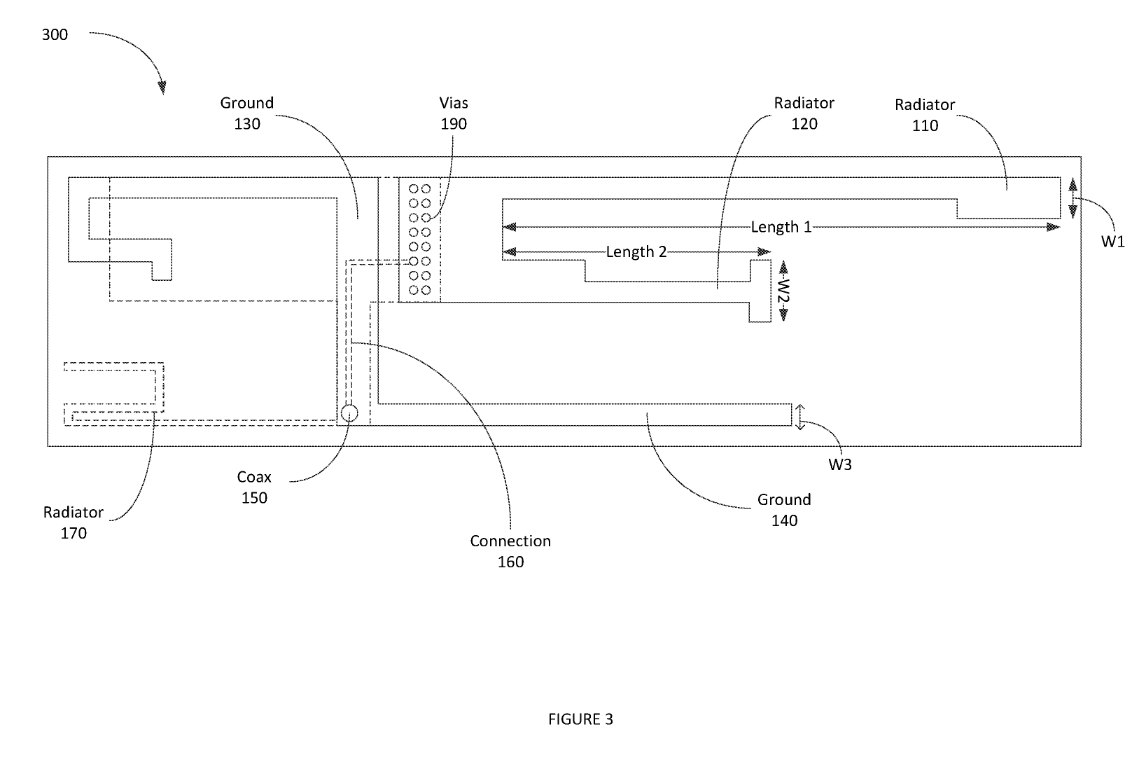

Referring now to FIG. 3, the first side and the second side of the antenna of FIGS. 1 and 2 according to some embodiments is shown. It is appreciated that the first side view of the antenna in FIG. 1 is shown and the components described in FIG. 2 are shown by dashed lines.

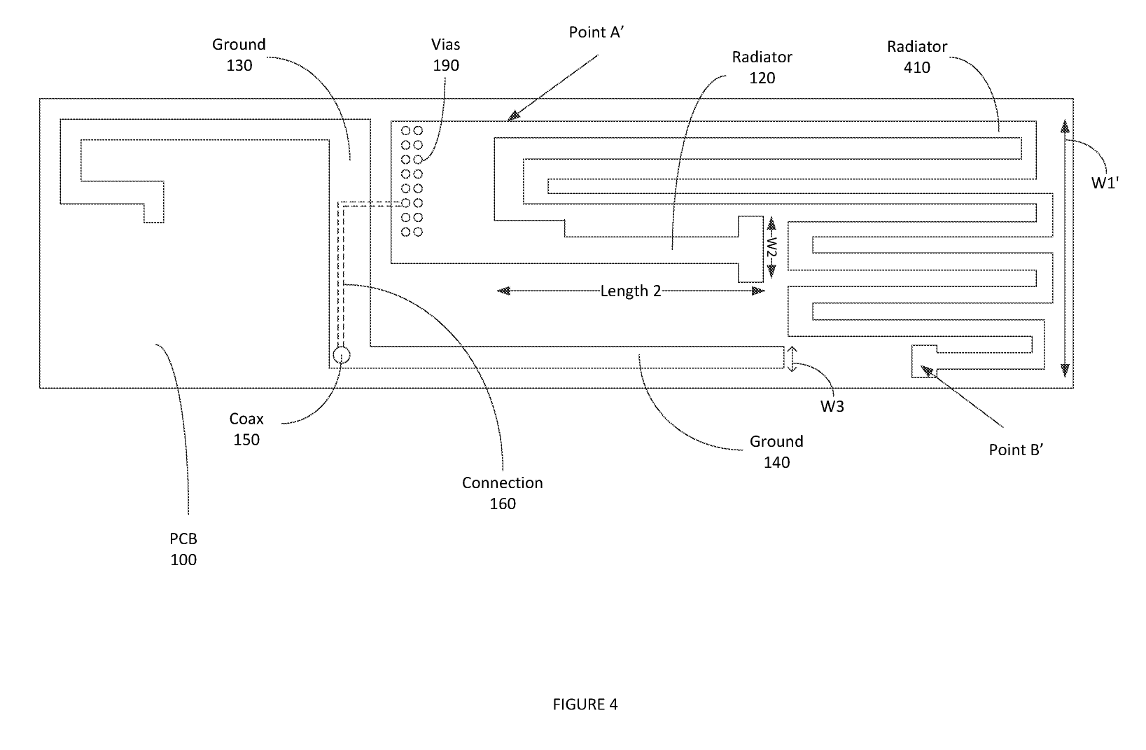

Referring now to FIG. 4, a first side of an antenna according to a different embodiment is shown. This embodiment is substantially similar to that of FIGS. 1-3 except the radiator 410 has replaced radiator 110. In this embodiment, radiator 410 has a larger length than radiator 110. In this embodiment, unutilized PCB 100 space is used to increase the length of the radiator 410 in order for the radiator 410 to resonate at an even lower center frequency in comparison to that of radiator 110. The length of the radiator 410 is the length between points A′ to B′. As such, the radiator 410 resonates over a center frequency that is lower than 800-900 MHz of that discussed with respect to FIGS. 1-3.

Moreover, in this embodiment, the bandwidth of the radiator 410 is selected and configured based on the “T” shaped end of the radiator 410. It is appreciated that in some embodiments, the bandwidth associated with the radiator 410 may be based on the entire width of the radiator 410 designated as W1′.

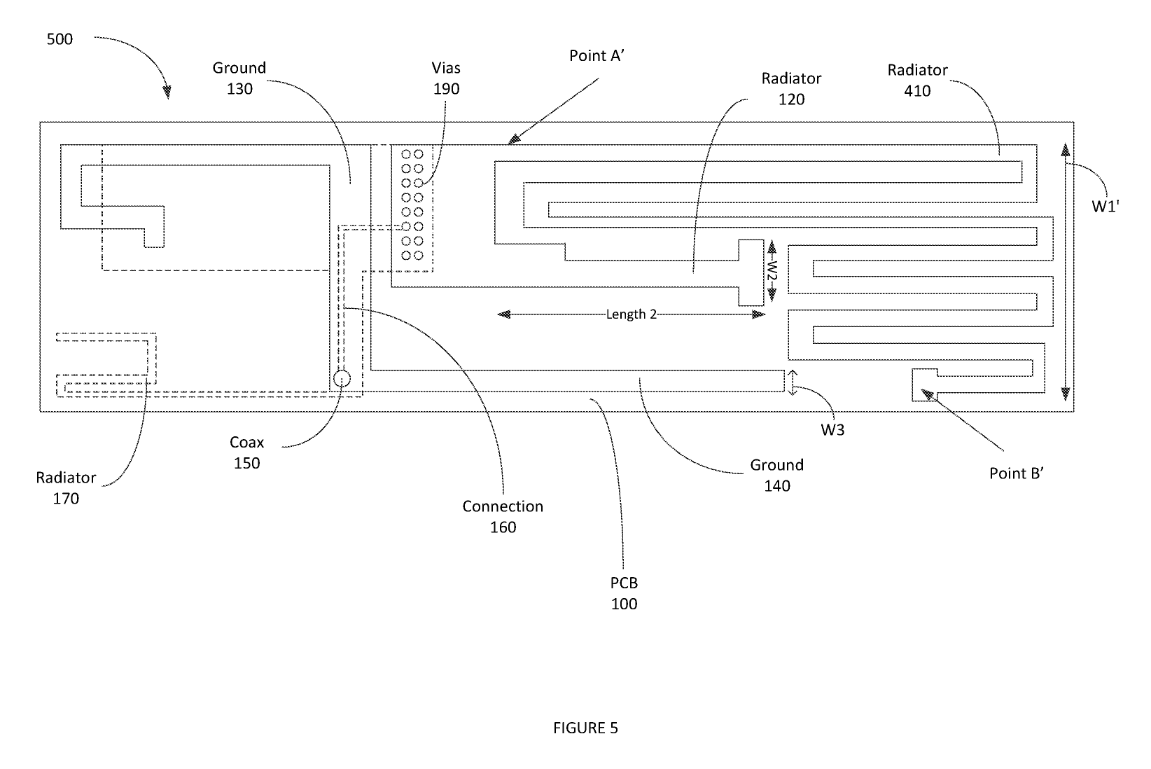

Referring now to FIG. 5, the first side and the second side of an antenna of FIG. 4 according to some embodiments is shown. In this embodiment, the first side of the antenna is shown as solid lines and the second side of the antenna is shown as dashed lines. In some embodiments, the radiators 410 and 170 are non-overlapping radiators. In some embodiments, the radiators 120 and 170 are non-overlapping radiators. Furthermore, in some embodiments, the radiators 410, 120, and 170 are non-overlapping radiators. It is appreciated that description of the embodiments with references to quarter wavelength is exemplary and not intended to limit the scope of the embodiments. For example, other wavelengths may be used, e.g., half wavelength, etc. Moreover, it is appreciated that the described embodiments that show two radiators on one side and one on the other side of the PCB, one ground reference plane shared by two radiators, and a dedicated ground reference plane by the radiator on the back side are exemplary and not intended to limit the scope of the embodiments. For example, any number of radiators and reference ground planes (whether shared by one or more radiators or not) may be used on one side, two sides, or a combination thereof.

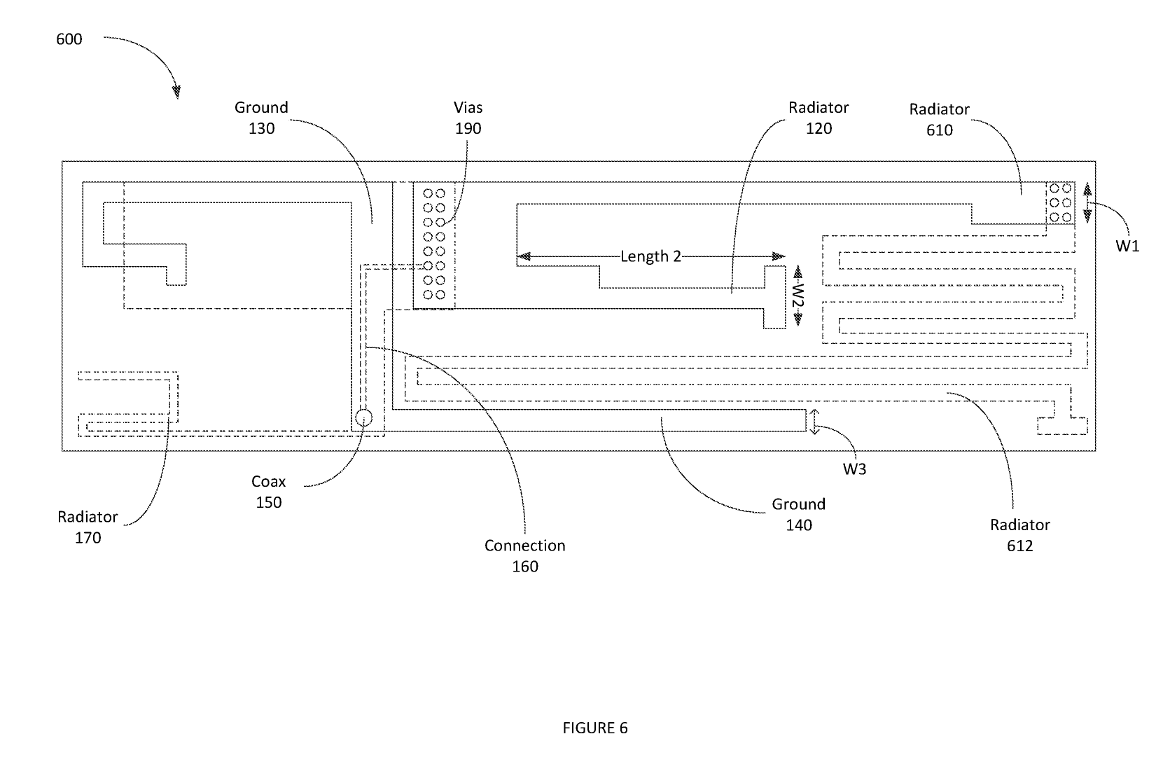

Referring now to FIG. 6, an antenna according to some alternative embodiments is shown. The embodiment shown in FIG. 6 is substantially similar to that of FIGS. 1-5 except that radiator 610, substantially similar in length and shape to that of FIGS. 1 and 3, is extended to have a larger length by connecting it to radiator 612 on the back side of the PCB 100 through vias 614. In other words, instead of utilizing unused PCB 100 space on the front side which is on the same side as radiators 610 and 120, the back side of the PCB 100 is used to connect the radiator 612 to the radiator 610 through vias 614, thereby increasing the length and causing it to resonate at a lower center frequency than that of radiator 110 in FIGS. 1-3. It is appreciated that in some embodiments, the thickness of the PCB 100 may be increased from that of FIGS. 1-5 of 0.031″ in order to reduce signal interference between the first side and the second side of the PCB and antennas associated therewith.

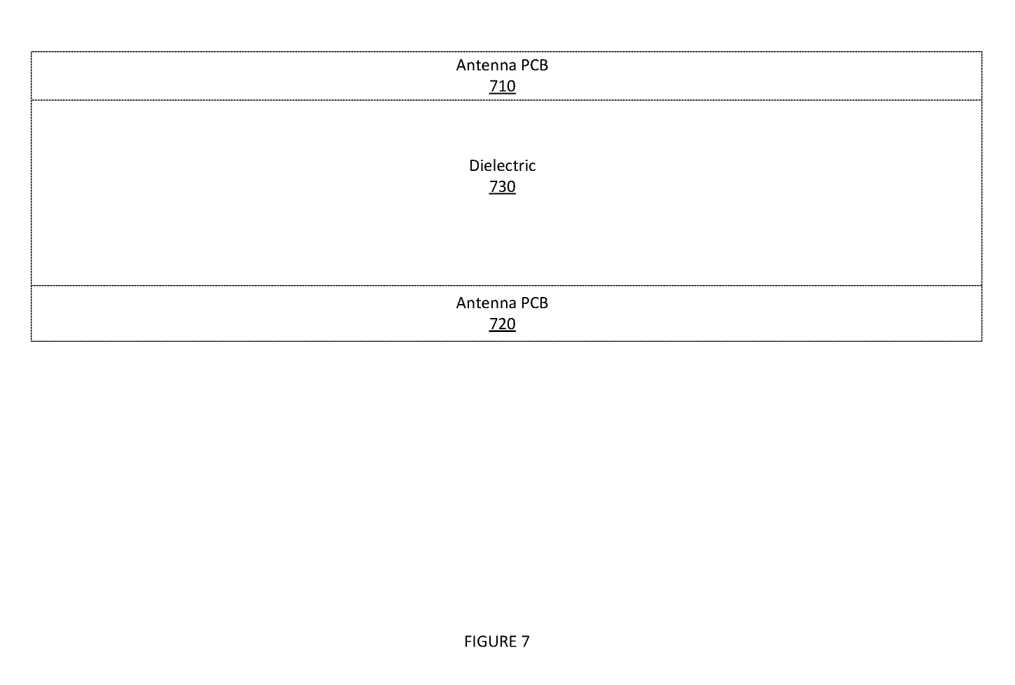

Referring now to FIG. 7, two antennas integrated within according to some embodiments is shown. In some embodiments, one antenna PCB 710 may be similar to any of the embodiments of FIGS. 1-6 described above. In some embodiments, another antenna PCB 720 may be similar to any of the embodiments of FIGS. 1-6 described above. The two antenna PCBs 710 and 720 may be separated by a dielectric 730, e.g., FR4 material. It is appreciated that the dielectric 730 may be made of other material such as a gel or any other material to isolate and reduce signal interferences between the first antenna PCB 710 and the second antenna PCB 720 and vice versa. It is also appreciated that the thickness of the dielectric 730 may be 0.031″ and it may be increased in order to reduce signal interferences between the two antenna PCBs 710 and 720.

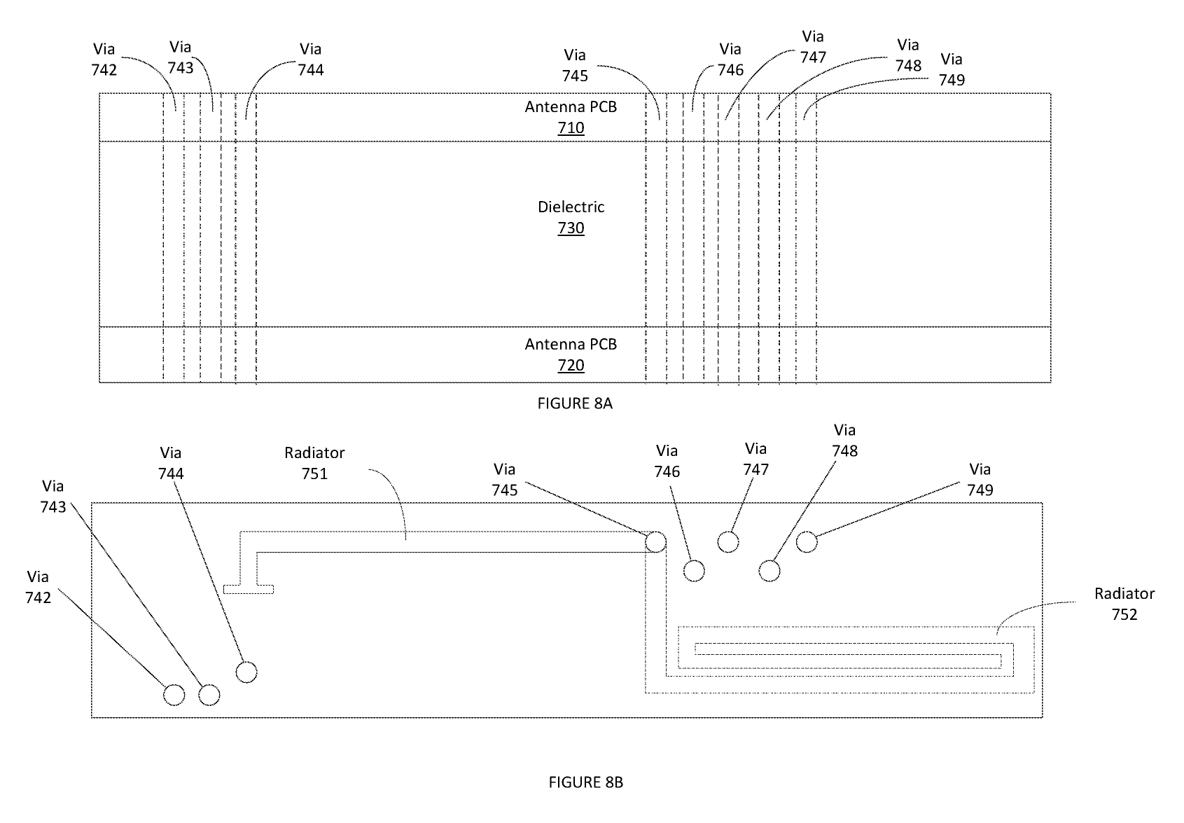

Referring now to FIGS. 8A-8B, a side view and a top view of an antenna according to some embodiments is shown. Referring specifically to FIG. 8A, the two antenna PCBs 710 and 720 separated by the dielectric 730 is shown. In this embodiment, the two antenna PCBs 710 and 720 may be connected to one another through various vias, e.g., vias 742-749. It is appreciated that each antenna PCB 710 and 720 may be similar to any of the embodiments of the antennas described in any of the FIGS. 1-6. For example, a via 742 may provide a connection between a radiator from the antenna PCB 710 to a reference plane capacitance positioned on the antenna PCB 720. In another embodiment, the via 742 may provide a connection between a radiator from the antenna PCB 710 to a radiator positioned on the antenna PCB 720 in order to increase the length of the radiator such that the radiator resonates at lower frequency wavelengths, e.g., by capturing a quarter wavelength signals for increasing the signal strength. It is appreciated that the vias 742-749 may provide a connection between any two radiator, a radiator and a reference plane capacitance, or any combination thereof, between the antenna PCB 710 and the antenna PCB 720.

Referring now to FIG. 8B, a top view of the antenna in FIG. 8A is shown. It is appreciated that in this embodiment, only one radiator 751 disposed on the top side of antenna PCB 710 is shown connected through via 745 to another radiator 752 disposed at the antenna PCB 720 in order not to obscure other features of the embodiments. It is appreciated that one of the radiators 751 or 752 may be replaced by a reference plane capacitance instead. It is further appreciated that other vias 742, 743, 744, 746, 474, 748 and 749 may similarly be used to connect radiators, and reference plane capacitance between the antenna PCB 710 and the antenna PCB 720.

It is appreciated that the number of radiators, reference plane capacitances, vias, etc., is exemplary and for illustration purposes only and not intended to limit the scope of the embodiments.

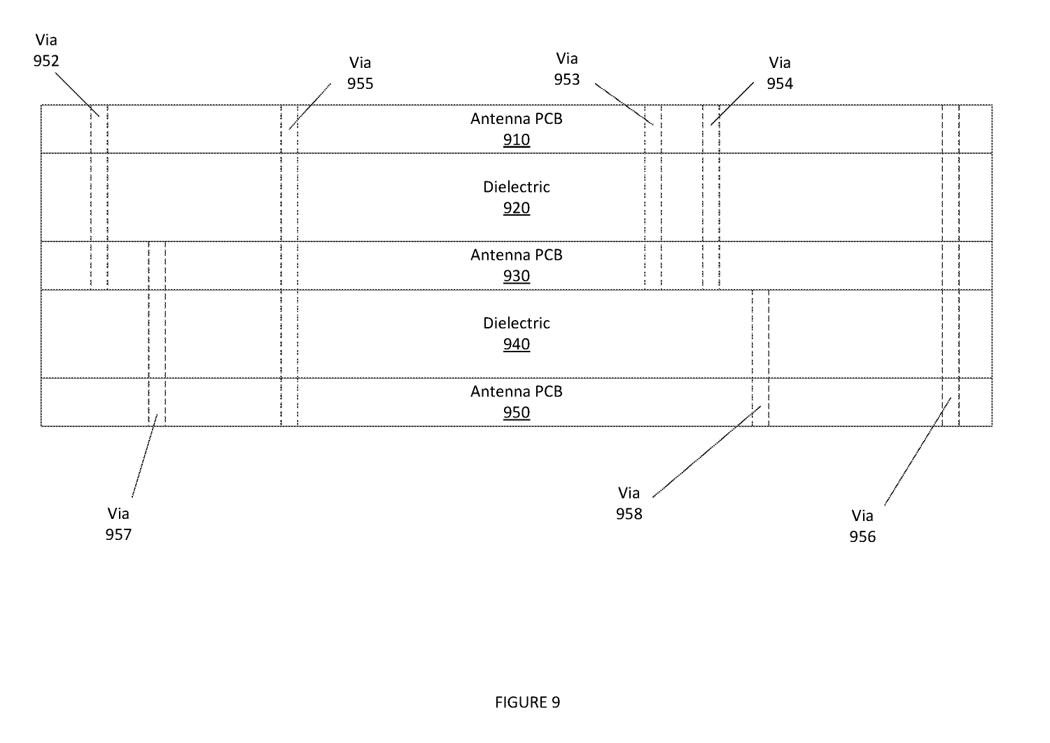

Referring now to FIG. 9, a stacked antenna according to some embodiments is shown. In some embodiments, multiple antenna PCBs and multiple dielectric layers can be used. For example, an antenna PCB 910 may be separated from the antenna PCB 930 by the dielectric layer 920. Moreover, the antenna PCB 930 may be separated from the antenna PCB 950 by the dielectric layer 940. It is appreciated that the antenna PCBs 910, 930, and 950 may be structured or function according to any of the embodiments described in FIGS. 1-8B. The dielectric layers 920 and 940 are similar to the dielectrics described in FIGS. 1-8B. In this embodiment, a radiator/reference plane capacitance on the antenna PCB 910 may be connected to another radiator/reference plane capacitance on the antenna PCB 950 through one or more vias 955 and 956. A radiator/reference plane capacitance on the antenna PCB 910 may be connected to another radiator/reference plane capacitance on the antenna PCB 930 through one or more vias 952, 953, and 954. A radiator/reference plane capacitance on the upper side of the antenna PCB 930 may be connected to another radiator/reference plane capacitance disposed at the bottom side of the antenna PCB 950 through via 957. A radiator/reference plane capacitance at the upper side of the antenna PCB 930 may be connected to another radiator/reference plane capacitance disposed at the bottom side of the antenna PCB 950 through via 958. It is further appreciated that similarly other radiators/reference plane capacitances may be connected from one antenna PCB to another (either top side or the bottom side). It is also appreciated that any number of antenna PCBs, vias, and/or dielectric layers may be used and that the specific configuration shown is for illustrative purposes only and should not be construed to limit the scope of the embodiments.

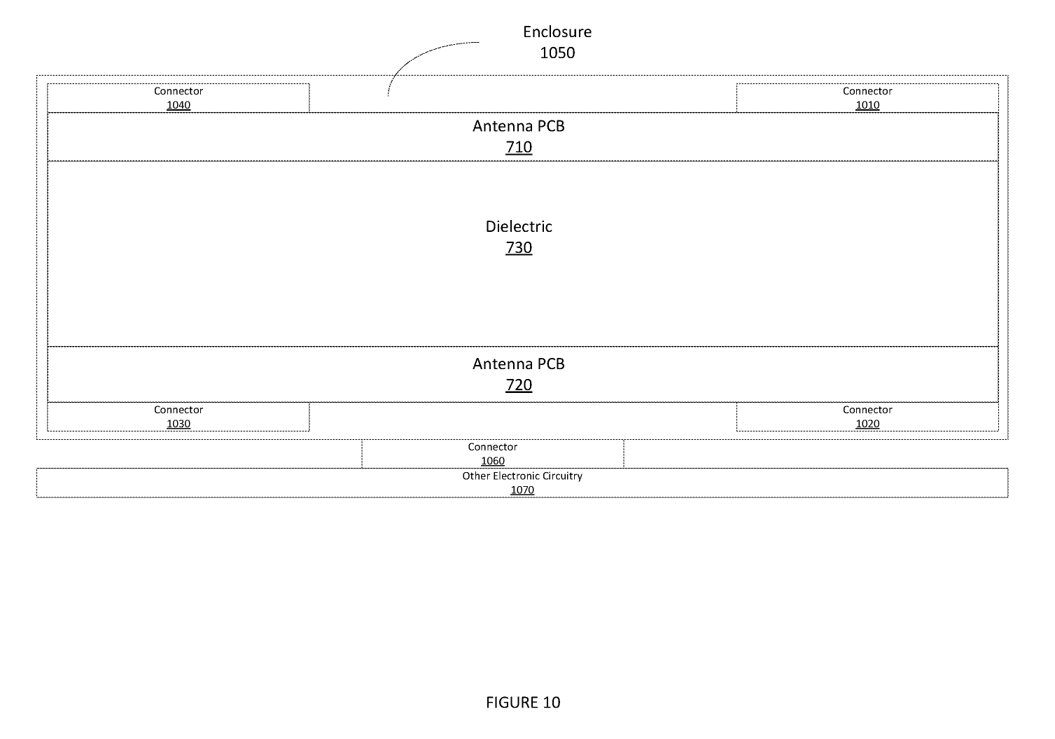

Referring now to FIG. 10, an integrated antenna according to some embodiments is shown. In this embodiment, two antenna PCBs 710 and 720 are shown separated by a dielectric layer 730. It is appreciated that the PCBs 710 and 720 and the dielectric layer 730 may be similar to those described in FIGS. 7-9. The antenna PCB 710 may include connections 1010 and 1040, and the antenna PCB 720 may include connections 1020 and 1030, in order to connect the antenna PCBs 710 and 720 within the enclosure 1050 to the external connection 1060. It is noted that the enclosure 1050 is shown without visually touching the connections 1010, 1020, 1030, and 1040 only to illustrate the boundaries of the enclosure. However, even though it is not shown, the enclosure 1050 is in fact connected to one or more of the connections 1010, 1020, 1030, and 1040 in order to make connection between the antenna PCBs 710 and 720 to the external connection 1060 that connects the integrated antenna to other electronic circuitries 1070 of the device. In other words, the enclosure 1050 that includes the antenna PCBs 710 and 720 may be connected to any circuitry, e.g., other electronic circuity 1070, and enable those electronic circuitries to transmit/receive signals using the PCB antennas. It is appreciated that in some embodiments, the enclosure 1050 may be removably connected to the other electronic circuitry 1070 through its external connection 1060.

Accordingly, a small form factor antenna(s) is provided at a high signal gain to capture lower frequency signals, e.g., lower LTE frequency. Moreover, an integrated antenna is shown to increase signal acquisition at various different bands, e.g., at 3 or more frequency ranges. It is appreciated that in some embodiments, the small form factor antenna may include two or more antennas for capturing quarter wavelength signals associated with LTE signals while it is removably and attachable to any electronic component or board to improve its signal strength and its flexibility with respect to various frequency ranges.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

What is claimed is:

1. An antenna comprising:
a dielectric material including a front side and a back side, wherein the front side is opposite the back side;
a first planar conducting element disposed on the front side configured to resonate over a first range of frequencies;
a second planar conducting element disposed on the back side configured to resonate over a second range of frequencies; and
a ground planar conducting element disposed on the front side, wherein a first portion of the ground planar conducting element is configured to provide a ground reference for the first planar conducting element, and wherein a second portion of the ground planar conducting element is configured to provide a ground reference for the second planar conducting element, and wherein resonance over the first range of frequencies is associated with a length of the first portion of the ground planar conducting element and a length of the first planar conducing element, and wherein resonance over the second range of frequencies is associated with a length of the second portion of the ground planar conducting element and a length of the second planar conducting element.

2. The antenna of claim 1 further comprising:
a third planar conducting element disposed on the front side configured to resonate over a third range of frequencies, and wherein the first portion of the ground planar conducting element is further configured to provide the ground reference for the third planar conducting element, and wherein resonance over the third range of frequencies is associated with the length of the first portion of the ground planar conducting element and a length of the third planar conducting element.

3. The antenna of claim 2 further comprising:
a plurality of vias configured to electrically connect the first planar conducting element and the third planar conducting element to a fourth conducting element disposed on the back side for increasing reference plane capacitance associated with the first planar conducting element and the third planar conducting element.

4. The antenna of claim 2, wherein the third range of frequencies is between 1500-2000 MHz.

5. The antenna of claim 2, wherein the first planar conducting element, the second planar conducting element, and the third planar conducting element are non-overlapping.

6. The antenna of claim 1 further comprising a via hole configured to couple the second planar conducting element to the second portion of the ground planar conducting element.

7. The antenna of claim 1, wherein the first range of frequencies is between 800-900 MHz and wherein the second range of frequencies is between 2000-2500 MHz.

8. The antenna of claim 1, wherein the first planar conducting element and the second planar conducting element are non-overlapping.

9. The antenna of claim 1, wherein the length of the first planar conducting element and the length of the first portion of the ground planar conducting element is configured to capture a quarter wavelength signal for the first range of frequencies.

10. The antenna of claim 1, wherein the dielectric material comprises FR4 material.

11. The antenna of claim 1, wherein the dielectric material, the first planar conducting element, the second planar conducting element, and the ground planar are disposed on a printed circuit board (PCB).

12. The antenna of claim 1, wherein the length of the first planar conducting element and the length of the first portion of the ground planar conducting element is configured to capture a quarter wavelength signal for the first range of frequencies and is at least two and a half times the length of the second planar conducting element and the length of the second portion of the ground planar conducting element that is configured to capture a quarter wavelength signal for the second range of frequencies.

13. The antenna of claim 1, wherein the length of the first planar conducting element and the length of the first portion of the ground planar conducting element is configured to capture a quarter wavelength signal for the first range of frequencies associated with long term evolution (LTE).

14. The antenna of claim 1, wherein the antenna has a small form factor configured to be placed within a smartphone.

15. An antenna comprising:
a printed circuit board (PCB) including a front side and a back side, wherein the front side is opposite the back side;
a first conducting element disposed on the front side configured to resonate over a first range of frequencies;
a second conducting element disposed on the back side configured to resonate over a second range of frequencies; and
a ground conducting element disposed on the front side, wherein a first portion of the ground conducting element is configured to provide a ground reference for the first conducting element, and wherein a second portion of the ground conducting element is configured to provide a ground reference for the second conducting element, and wherein resonance over the first range of frequencies is associated with a length of the first portion of the ground conducting element and a length of the first conducing element, and wherein resonance over the second range of frequencies is associated with a length of the second portion of the ground conducting element and a length of the second conducting element.

16. The antenna of claim 15 further comprising:
a third conducting element disposed on the front side configured to resonate over a third range of frequencies, and wherein the first portion of the ground conducting element is further configured to provide the ground reference for the third conducting element, and wherein resonance over the third range of frequencies is associated with the length of the first portion of the ground conducting element and a length of the third conducting element.

17. The antenna of claim 16 further comprising:
a plurality of vias configured to electrically connect the first conducting element and the third conducting element to a fourth conducting element disposed on the back side for increasing reference plane capacitance associated with the first conducting element and the third conducting element.

18. The antenna of claim 16, wherein the third range of frequencies is between 1500-2000 MHz.

19. The antenna of claim 16, wherein the first conducting element, the second conducting element, and the third conducting element are non-overlapping.

20. The antenna of claim 15 further comprising a via hole configured to couple the second conducting element to the second portion of the ground conducting element.

21. The antenna of claim 15, wherein the first range of frequencies is between 800-900 MHz and wherein the second range of frequencies is between 2000-2500 MHz.

22. The antenna of claim 15, wherein the first conducting element and the second conducting element are non-overlapping.

23. The antenna of claim 15, wherein the length of the first conducting element and the length of the first portion of the ground conducting element is configured to capture a quarter wavelength signal for the first range of frequencies.

24. The antenna of claim 15, wherein the PCB comprises FR4 material.

25. The antenna of claim 15, wherein the length of the first conducting element and the length of the first portion of the ground conducting element is configured to capture a quarter wavelength signal for the first range of frequencies and is at least two and a half times the length of the second conducting element and the length of the second portion of the ground conducting element that is configured to capture a quarter wavelength signal for the second range of frequencies.

26. The antenna of claim 15, wherein the length of the first conducting element and the length of the first portion of the ground conducting element is configured to capture a quarter wavelength signal for the first range of frequencies associated with long term evolution (LTE).

27. The antenna of claim 15, wherein the antenna has a small form factor configured to be placed within a smartphone.

28. A smartphone comprising:
a printed circuit board (PCB) including a front side and a back side, wherein the front side is opposite the back side, wherein the PCB is positioned within the smartphone;
a first conducting element disposed on the front side configured to resonate over a first range of frequencies;
a second conducting element disposed on the back side configured to resonate over a second range of frequencies; and
a ground conducting element disposed on the front side, wherein a first portion of the ground conducting element is configured to provide a ground reference for the first conducting element, and wherein a second portion of the ground conducting element is configured to provide a ground reference for the second conducting element, and wherein resonance over the first range of frequencies is associated with a length of the first portion of the ground conducting element and a length of the first conducing element, and wherein resonance over the second range of frequencies is associated with a length of the second portion of the ground conducting element and a length of the second conducting element.

29. The smartphone of claim 28 further comprising:
a third conducting element disposed on the front side configured to resonate over a third range of frequencies, and wherein the first portion of the ground conducting element is further configured to provide the ground reference for the third conducting element, and wherein resonance over the third range of frequencies is associated with the length of the first portion of the ground conducting element and a length of the third conducting element.

30. The smartphone of claim 29 further comprising:
a plurality of vias configured to electrically connect the first conducting element and the third conducting element to a fourth conducting element disposed on the back side for increasing reference plane capacitance associated with the first conducting element and the third conducting element.

31. The smartphone of claim 29, wherein the third range of frequencies is between 1500-2000 MHz.

32. The smartphone of claim 29, wherein the first conducting element, the second conducting element, and the third conducting element are non-overlapping.

33. The smartphone of claim 28 further comprising a via hole configured to couple the second conducting element to the second portion of the ground conducting element.

34. The smartphone of claim 28, wherein the first range of frequencies is between 800-900 MHz and wherein the second range of frequencies is between 2000-2500 MHz.

35. The smartphone of claim 28, wherein the first conducting element and the second conducting element are non-overlapping.

36. The smartphone of claim 28, wherein the length of the first conducting element and the length of the first portion of the ground conducting element is configured to capture a quarter wavelength signal for the first range of frequencies.

37. The smartphone of claim 28, wherein the PCB comprises FR4 material.

38. The smartphone of claim 28, wherein the length of the first conducting element and the length of the first portion of the ground conducting element is configured to capture a quarter wavelength signal for the first range of frequencies and is at least two and a half times the length of the second conducting element and the length of the second portion of the ground conducting element that is configured to capture a quarter wavelength signal for the second range of frequencies.

39. The smartphone of claim 28, wherein the length of the first conducting element and the length of the first portion of the ground conducting element is configured to capture a quarter wavelength signal for the first range of frequencies associated with long term evolution (LTE).
